(19) United States
(12) Patent Application Publication
(10) Pub. No.: US 2018/0157641 A1
(43) Pub. Date: Jun. 7, 2018

(54) Automatic Detection of Required Tools for a Task Described in Natural Language Content

(71) Applicant: International Business Machines Corporation, Armonk, NY (US)

(72) Inventors: Donna K. Byron, Petersham, MA (US); Carmine M. DiMascio, West Roxbury, MA (US); Benjamin L. Johnson, Baltimore, MD (US); Florian Pinel, New York, NY (US)

(21) Appl. No.: 15/371,808

(22) Filed: Dec. 7, 2016

(51) Int. Cl. G06F 17/27; G06F 17/24; G06F 17/30; G06N 99/00

(52) U.S. Cl. CPC G06F 17/2785; G06F 17/241; G06F 17/2755; G06N 99/005; G06F 17/30011; G06F 17/30345; G06F 17/278

(57) ABSTRACT

Mechanisms are provided for automatically identifying required tools for performing actions specified in electronic documents. The mechanisms perform natural language processing of content of a training corpus of electronic documents to identify associations of action terms with required tools for performing actions corresponding to the action terms. The mechanisms train an ontology model based on the identified associations. The mechanisms perform analysis of electronic documents of one or more other corpora based on the trained ontology model to identify required tools for performing actions specified in the electronic documents. The mechanisms annotate one or more of the electronic documents of the one or more corpora to include required tools annotation metadata identifying tools required to perform actions corresponding to action terms present in the one or more electronic documents.

### BACKGROUND

The present application relates generally to an improved data processing apparatus and method and more specifically to mechanisms for automatic detection of required tools for performing an task described in natural language content.

With the increased usage of computing networks, such as the Internet, humans are currently inundated and overwhelmed with the amount of information available to them from various structured and unstructured sources. However, information gaps abound as users try to piece together what they can find that they believe to be relevant during searches for information on various subjects. To assist with such searches, recent research has been directed to generating Question and Answer (QA) systems which may take an input question, analyze it, and return results indicative of the most probable answer to the input question. QA systems provide automated mechanisms for searching through large sets of sources of content, e.g., electronic documents, and analyze them with regard to an input question to determine an answer to the question and a confidence measure as to how accurate an answer is for answering the input question.

Examples, of QA systems are Siri® from Apple®, Cortana® from Microsoft®, and question answering pipeline of the IBM Watson™ cognitive system available from International Business Machines (IBM®) Corporation of Armonk, N.Y. The IBM Watson™ system is an application of advanced natural language processing, information retrieval, knowledge representation and reasoning, and machine learning technologies to the field of open domain question answering. The IBM Watson™ system is built on IBM's DeepQA™ technology used for hypothesis generation, massive evidence gathering, analysis, and scoring. DeepQA™ takes an input question, analyzes it, decomposes the question into constituent parts, generates one or more hypothesis based on the decomposed question and results of a primary search of answer sources, performs hypothesis and evidence scoring based on a retrieval of evidence from evidence sources, performs synthesis of the one or more hypothesis, and based on trained models, performs a final merging and ranking to output an answer to the input question along with a confidence measure.

### SUMMARY

This Summary is provided to introduce a selection of concepts in a simplified form that are further described herein in the Detailed Description. This Summary is not intended to identify key factors or essential features of the claimed subject matter, nor is it intended to be used to limit the scope of the claimed subject matter.

In one illustrative embodiment, a method is provided, in a data processing system comprising a processor and a memory, wherein the memory comprises instructions executed by the processor to cause the processor to implement the method. The method comprises performing, by the data processing system, natural language processing of content of a training corpus of electronic documents to identify associations of action terms with required tools for performing actions corresponding to the action terms. The method also comprises training, by the data processing system, an ontology model based on the identified associations of the action terms with required tools for performing actions corresponding to the action terms. In addition, the method comprises performing, by the data processing system, analysis of electronic documents of one or more other corpora based on the trained ontology model to identify required tools for performing actions specified in the electronic documents. Moreover, the method comprises annotating, by the data processing system, one or more of the electronic documents of the one or more corpora to include required tools annotation metadata identifying tools required to perform actions corresponding to action terms present in the one or more electronic documents to thereby generate at least one updated corpus.

In other illustrative embodiments, a computer program product comprising a computer useable or readable medium having a computer readable program is provided. The computer readable program, when executed on a computing device, causes the computing device to perform various ones of, and combinations of, the operations outlined above with regard to the method illustrative embodiment.

In yet another illustrative embodiment, a system/apparatus is provided. The system/apparatus may comprise one or more processors and a memory coupled to the one or more processors. The memory may comprise instructions which, when executed by the one or more processors, cause the one or more processors to perform various ones of, and combinations of, the operations outlined above with regard to the method illustrative embodiment.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 depicts a schematic diagram of one illustrative embodiment of a cognitive system in a computer network;

FIG. 2 is a block diagram of an example data processing system in which aspects of the illustrative embodiments are implemented;

FIG. 3 illustrates a cognitive system processing pipeline for processing a natural language input to generate a response or result in accordance with one illustrative embodiment; and

FIG. 4 is a flowchart outlining an example operation for automatically detecting required tools for performing a task and generating a cognitive response to an input request based on the detected required tools in accordance with one illustrative embodiment.

### DETAILED DESCRIPTION

The illustrative embodiments provide mechanisms for automatically detecting required tools for performing a task described in natural language content. That is, it has been recognized that in many domains, tools play a particular role in actually accomplishing a task described in natural language content. However, as with other common sense elements of natural language understanding, the required tool is often unmentioned in the natural language content itself. Thus, natural language processing mechanisms may not be able to determine from the natural language content itself what tools are required to successfully complete a task.

It should be noted that the term “tool” refers to any device or implement used to accomplish a task. Examples of tools include hardware tools such as hammers, screwdrivers, saws, etc. Tools may also include utensils such as spoons, knives, whisks, and other cooking implements such as pots, pans, blenders, food processors, ovens, various cooking appliances, etc. Furthermore, tools may include particular computing devices, software, or other physical or virtual computing elements. The various types of devices and implements that fall within the scope of the term “tool” is vast and all tools cannot be specifically identified herein. What constitutes a tool is dependent upon the particular domain upon which the mechanisms of the illustrative embodiments are implemented.

Understanding what tools are required or implied by the natural language content and yet not explicitly stated in the natural language content is important to a variety of different domains. For example, in a cooking domain, as kitchen appliance manufacturers are racing to create a “cognitive kitchen”, it becomes essential to understand what tools are used in recipes, along with when an how these tools are used, so that they can be automatically instrumented. In a larger sense, in mechanisms that create instruction sequences from free form content, instructions need to be decomposed to identify the tools, and therefore the skills, required to perform the instructions in the sequence. This is especially helpful for do-it-yourself (DIY) activities where populating the “what you'll need” section of the instruction sequence is a helpful addition to assist the user in preparing to perform the activity. This may also be useful when helping field technicians and the like to gather their tools before setting forth on a service call.

More generally, planning and reasoning engines require knowledge about what tools are required for tasks. For instance, suppose that an agent (either a virtual or robotic agent) is going to attempt a task. The agent will need to know what tools are required for the task and may need to create additional tasks around the acquisition of the required tools.

While it is important in many scenarios to know what tools are required to accomplish a task, many times the tools themselves are not explicitly mentioned in the natural language content describing the task. Documents, especially instructive texts, often imply the use of certain tools and rely on the reader's common sense knowledge to know when certain tools are required. The following are examples of some natural language statements that may appear in natural language documents, in which tools are implied and not explicitly stated:

1. “Toast hazelnuts on a baking sheet, stirring occasionally, until golden brown.”—this statement explicitly mentions the baking sheet but implies another tool needed to do the stirring (e.g., a wooden spoon or spatula) and an oven for toasting;
2. “Drain pasta, reserving 1½ cups pasta cooking liquid.”—requires some kind of tool for straining and also a bowl or other container to hold the reserved liquid;
3. “Attach the arm to the center support with the carriage bolts.”—may require a drill to drill a hole that accommodates the carriage bolt (if not already drilled) and a ratchet to tighten the nuts;
4. “Evaluate the patient's condition with an MRI.”—requires an MRI scanner. Current knowledge sources for performing natural language processing of natural language documents are incomplete with respect to what tools are required for certain actions or events of tasks. Manual acquisition of this knowledge is time-consuming and resource intensive. Thus, it would be beneficial to have mechanisms that would learn which tools are required for various actions or events of tasks.

The illustrative embodiments provide mechanisms for building and utilizing a knowledge resource that comprises associations between domain specific actions and required tools for performing those domain specific actions. The mechanisms of at least some of the illustrative embodiments provide functionality for inferring when tools are required for a domain specific action although they may not be explicitly mentioned in the natural language content itself. The mechanisms of at least some of the illustrative embodiments provide functionality for optimizing summaries or sequences of instructions based on similar tools required to perform domain specific actions. The mechanisms of at least some of the illustrative embodiments provide functionality for displaying advertisements or other information about tools that are required to perform actions for a task. The mechanisms of at least some the illustrative embodiments provide functionality for creating a tools manifest to accompany the natural language description of a task, e.g., a “What you'll need” section of the task description.

In particular, the illustrative embodiments receive an input corpus of electronic documents comprising natural language content and, through natural language processing and a database of tools characteristics information for the particular domain, generates knowledge data structures that correlate actions with required tools and a confidence level that the action and tool are associated with one another. In some illustrative embodiments, the knowledge data structures are tuples, such as a 4-tuple of the type {action, required tool, object, confidence level} or a 3-tuple of the type {action, required tool, confidence level}. The “object” in the 4-tuple represents the object upon which the action is performed and thus, the same combination of action and required tool may be applied to different objects with different levels of confidence. The knowledge data structures may be used to populate a knowledge resource such an ontology or knowledge graph that is used to train models which may be applied to identify what tools are required by other natural language descriptions of tasks even though the tools may not be explicitly mentioned in the natural language descriptions.

Thus, the illustrative embodiments operate in two phases where the first phase is a learning phase in which electronic documents of a training corpus (which may or may not be the corpus upon which runtime operations are performed), are used to learn what tools are used in what contexts based on explicit mentions of such tools with actions, and the second phase is applying this knowledge to identify all tools mentioned explicitly or implicitly in natural language descriptions of tasks. It should be appreciated that the two phases may be applied sequentially to the same electronic document or portion of natural language content.

Before beginning the discussion of the various aspects of the illustrative embodiments in more detail, it should first be appreciated that throughout this description the term “mechanism” will be used to refer to elements of the present invention that perform various operations, functions, and the like. A “mechanism,” as the term is used herein, may be an implementation of the functions or aspects of the illustrative embodiments in the form of an apparatus, a procedure, or a computer program product. In the case of a procedure, the procedure is implemented by one or more devices, apparatus, computers, data processing systems, or the like. In the case of a computer program product, the logic represented by computer code or instructions embodied in or on the computer program product is executed by one or more hardware devices in order to implement the functionality or perform the operations associated with the specific “mechanism.” Thus, the mechanisms described herein may be implemented as specialized hardware, software executing on general purpose hardware, software instructions stored on a medium such that the instructions are readily executable by specialized or general purpose hardware, a procedure or method for executing the functions, or a combination of any of the above.

The present description and claims may make use of the terms “a”, “at least one of”, and “one or more of” with regard to particular features and elements of the illustrative embodiments. It should be appreciated that these terms and phrases are intended to state that there is at least one of the particular feature or element present in the particular illustrative embodiment, but that more than one can also be present. That is, these terms/phrases are not intended to limit the description or claims to a single feature/element being present or require that a plurality of such features/elements be present. To the contrary, these terms/phrases only require at least a single feature/element with the possibility of a plurality of such features/elements being within the scope of the description and claims.

Moreover, it should be appreciated that the use of the term “engine,” if used herein with regard to describing embodiments and features of the invention, is not intended to be limiting of any particular implementation for accomplishing and/or performing the actions, steps, processes, etc., attributable to and/or performed by the engine. An engine may be, but is not limited to, software, hardware and/or firmware or any combination thereof that performs the specified functions including, but not limited to, any use of a general and/or specialized processor in combination with appropriate software loaded or stored in a machine readable memory and executed by the processor. Further, any name associated with a particular engine is, unless otherwise specified, for purposes of convenience of reference and not intended to be limiting to a specific implementation. Additionally, any functionality attributed to an engine may be equally performed by multiple engines, incorporated into and/or combined with the functionality of another engine of the same or different type, or distributed across one or more engines of various configurations.

In addition, it should be appreciated that the following description uses a plurality of various examples for various elements of the illustrative embodiments to further illustrate example implementations of the illustrative embodiments and to aid in the understanding of the mechanisms of the illustrative embodiments. These examples intended to be non-limiting and are not exhaustive of the various possibilities for implementing the mechanisms of the illustrative embodiments. It will be apparent to those of ordinary skill in the art in view of the present description that there are many other alternative implementations for these various elements that may be utilized in addition to, or in replacement of, the examples provided herein without departing from the spirit and scope of the present invention.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

As noted above, the present invention provides mechanisms for automatic detection of required tools for performing a task described in natural language content. The mechanisms utilize natural language processing mechanisms for obtaining knowledge about the associations of domain specific actions with tools used to perform those actions. The mechanisms further utilize that knowledge to perform cognitive operations based on analysis of natural language electronic documents in one or more corpora. In particular, the cognitive operations may comprise generating cognitive responses to user requests and/or questions which may be posed in a structured or unstructured manner. For example, in one illustrative embodiment, the mechanisms of the illustrative embodiments may be used to provide instructions, in an output to a user, regarding the way in which a task is to be accomplished and may identify what tools are required for the actions identified in the instructions, even in cases where the tools themselves may not be explicitly mentioned in the instructions. In some illustrative embodiments, the cognitive operation may be to augment or otherwise modify the natural language content of the electronic documents, or their metadata, to make explicit the tools required for actions described in the electronic documents.

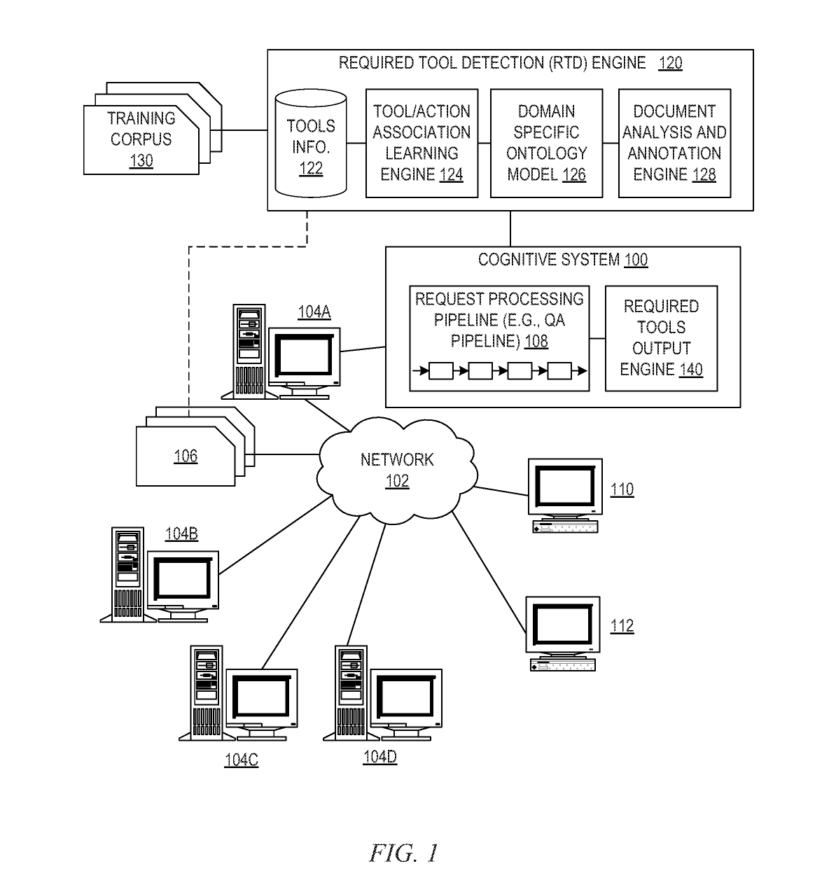

The illustrative embodiments may be utilized in many different types of data processing environments. In order to provide a context for the description of the specific elements and functionality of the illustrative embodiments, FIGS. 1-3 are provided hereafter as example environments in which aspects of the illustrative embodiments may be implemented. It should be appreciated that FIGS. 1-3 are only examples and are not intended to assert or imply any limitation with regard to the environments in which aspects or embodiments of the present invention may be implemented. Many modifications to the depicted environments may be made without departing from the spirit and scope of the present invention.

FIGS. 1-3 are directed to describing an example cognitive system for acquiring knowledge of required tools for domain specific actions and utilizing that knowledge to processing user requests or questions. The cognitive system in these examples implements a request processing pipeline, such as a Question Answering (QA) pipeline (also referred to as a Question/Answer pipeline or Question and Answer pipeline) for example, request processing methodology, and request processing computer program product with which the mechanisms of the illustrative embodiments are implemented. These requests may be provided as structure or unstructured request messages, natural language questions, or any other suitable format for requesting an operation to be performed by the cognitive system. As described in more detail hereafter, the particular application that is implemented in the cognitive system of the present invention is an application for providing a user with instructions regarding how to perform a task in which tools for performing the actions specified in the instructions are explicitly identified even if they were not explicitly indicated in the original instructions of an electronic corpus of documents from which the instructions were obtained.

It should be appreciated that the cognitive system, while shown as having a single request processing pipeline in the examples hereafter, may in fact have multiple request processing pipelines. Each request processing pipeline may be separately trained and/or configured to process requests associated with different domains or be configured to perform the same or different analysis on input requests (or questions in implementations using a QA pipeline), depending on the desired implementation. For example, in some cases, a first request processing pipeline may be trained to operate on input requests directed to obtaining instructions regarding how to complete tasks in a medical domain, cooking domain, financial domain, do-it-yourself (DIY) project domain, etc. In other cases, for example, the request processing pipelines may be configured to provide different types of cognitive functions or support different types of applications, such as one request processing pipeline being used for providing instructions for completing tasks, e.g., “Provide a recipe for baked chicken casserole”, another pipeline used for answering questions about instructions for completing tasks, e.g., “How do I drill a hole in the metal plate?”, etc.

Moreover, each request processing pipeline may have their own associated corpus or corpora that they ingest and operate on, e.g., one corpus for cooking domain related documents and another corpus for medical domain related documents in the above examples. In some cases, the request processing pipelines may each operate on the same domain of input questions but may have different configurations, e.g., different annotators or differently trained annotators, such that different analysis and potential answers are generated. The cognitive system may provide additional logic for routing input questions to the appropriate request processing pipeline, such as based on a determined domain of the input request, combining and evaluating final results generated by the processing performed by multiple request processing pipelines, and other control and interaction logic that facilitates the utilization of multiple request processing pipelines.

As noted above, one type of request processing pipeline with which the mechanisms of the illustrative embodiments may be utilized is a Question Answering (QA) pipeline. The description of example embodiments of the present invention hereafter will utilize a QA pipeline as an example of a request processing pipeline that may be augmented to include mechanisms in accordance with one or more illustrative embodiments. It should be appreciated that while the present invention will be described in the context of the cognitive system implementing one or more QA pipelines that operate on an input question, the illustrative embodiments are not limited to such. Rather, the mechanisms of the illustrative embodiments may operate on requests that are not posed as “questions” but are formatted as requests for the cognitive system to perform cognitive operations on a specified set of input data using the associated corpus or corpora and the specific configuration information used to configure the cognitive system. For example, rather than asking a natural language question of “What is a recipe for baked chicken casserole?” the cognitive system may instead receive a request of “provide a recipe for baked chicken casserole,” or the like. It should be appreciated that the mechanisms of the QA system pipeline may operate on requests in a similar manner to that of input natural language questions with minor modifications. In fact, in some cases, a request may be converted to a natural language question for processing by the QA system pipelines if desired for the particular implementation.

As will be discussed in greater detail hereafter, the illustrative embodiments may be integrated in, augment, and extend the functionality of these QA pipeline, or request processing pipeline, mechanisms by providing additional mechanisms to learn associations of domain specific actions with corresponding required tools and then apply that acquired knowledge to the processing of natural language content to perform cognitive operations. In particular, the required tool knowledge acquired may be applied to natural language documents of a corpus when ingesting such documents so as to annotate or modify those documents to make explicit the required tools for the actions specified in those documents. The annotated or modified documents may be used by the cognitive system to perform cognitive operations, such as answering user questions, responding to user requests for information, and the like. In other illustrative embodiments, the acquired knowledge may be used as part of the runtime processing of user questions/requests so as to provide a response to the user that includes the required tools to perform actions specified in the response.

Since the illustrative embodiments operate in conjunction with a cognitive system having a request processing pipeline, which in some embodiments may be a question answering (QA) pipeline, it is important to first have an understanding of how cognitive systems, and question and answer creation in a cognitive system implementing a QA pipeline, is implemented before describing how the mechanisms of the illustrative embodiments are integrated in and augment such cognitive systems and request processing pipeline, or QA pipeline, mechanisms. It should be appreciated that the mechanisms described in FIGS. 1-3 are only examples and are not intended to state or imply any limitation with regard to the type of cognitive system mechanisms with which the illustrative embodiments are implemented. Many modifications to the example cognitive system shown in FIGS. 1-3 may be implemented in various embodiments of the present invention without departing from the spirit and scope of the present invention.

As an overview, a cognitive system is a specialized computer system, or set of computer systems, configured with hardware and/or software logic (in combination with hardware logic upon which the software executes) to emulate human cognitive functions. These cognitive systems apply human-like characteristics to conveying and manipulating ideas which, when combined with the inherent strengths of digital computing, can solve problems with high accuracy and resilience on a large scale. A cognitive system performs one or more computer-implemented cognitive operations that approximate a human thought process as well as enable people and machines to interact in a more natural manner so as to extend and magnify human expertise and cognition. A cognitive system comprises artificial intelligence logic, such as natural language processing (NLP) based logic, for example, and machine learning logic, which may be provided as specialized hardware, software executed on hardware, or any combination of specialized hardware and software executed on hardware. The logic of the cognitive system implements the cognitive operation(s), examples of which include, but are not limited to, question answering, identification of related concepts within different portions of content in a corpus, intelligent search algorithms, such as Internet web page searches, for example, medical diagnostic and treatment recommendations, and other types of recommendation generation, e.g., items of interest to a particular user, potential new contact recommendations, or the like.

IBM Watson™ is an example of one such cognitive system which can process human readable language and identify inferences between text passages with human-like high accuracy at speeds far faster than human beings and on a larger scale. In general, such cognitive systems are able to perform the following functions:
Navigate the complexities of human language and understanding
Ingest and process vast amounts of structured and unstructured data
Generate and evaluate hypothesis
Weigh and evaluate responses that are based only on relevant evidence
Provide situation-specific advice, insights, and guidance
Improve knowledge and learn with each iteration and interaction through machine learning processes
Enable decision making at the point of impact (contextual guidance)
Scale in proportion to the task
Extend and magnify human expertise and cognition
Identify resonating, human-like attributes and traits from natural language
Deduce various language specific or agnostic attributes from natural language
High degree of relevant recollection from data points (images, text, voice) (memorization and recall)
Predict and sense with situational awareness that mimic human cognition based on experiences
Answer questions based on natural language and specific evidence

In one aspect, cognitive systems provide mechanisms for answering questions posed to these cognitive systems using a Question Answering pipeline or system (QA system) and/or process requests which may or may not be posed as natural language questions. The QA pipeline or system is an artificial intelligence application executing on data processing hardware that answers questions pertaining to a given subject-matter domain presented in natural language. The QA pipeline receives inputs from various sources including input over a network, a corpus of electronic documents or other data, data from a content creator, information from one or more content users, and other such inputs from other possible sources of input. Data storage devices store the corpus of data. A content creator creates content in a document for use as part of a corpus of data with the QA pipeline. The document may include any file, text, article, or source of data for use in the QA system. For example, a QA pipeline accesses a body of knowledge about the domain, or subject matter area, e.g., financial domain, medical domain, legal domain, etc., where the body of knowledge (knowledgebase) can be organized in a variety of configurations, e.g., a structured repository of domain-specific information, such as ontologies, or unstructured data related to the domain, or a collection of natural language documents about the domain.

Content users input questions to cognitive system which implements the QA pipeline. The QA pipeline then answers the input questions using the content in the corpus of data by evaluating documents, sections of documents, portions of data in the corpus, or the like. When a process evaluates a given section of a document for semantic content, the process can use a variety of conventions to query such document from the QA pipeline, e.g., sending the query to the QA pipeline as a well-formed question which is then interpreted by the QA pipeline and a response is provided containing one or more answers to the question. Semantic content is content based on the relation between signifiers, such as words, phrases, signs, and symbols, and what they stand for, their denotation, or connotation. In other words, semantic content is content that interprets an expression, such as by using Natural Language Processing.

As will be described in greater detail hereafter, the QA pipeline receives an input question, parses the question to extract the major features of the question, uses the extracted features to formulate queries, and then applies those queries to the corpus of data. Based on the application of the queries to the corpus of data, the QA pipeline generates a set of hypotheses, or candidate answers to the input question, by looking across the corpus of data for portions of the corpus of data that have some potential for containing a valuable response to the input question. The QA pipeline then performs deep analysis on the language of the input question and the language used in each of the portions of the corpus of data found during the application of the queries using a variety of reasoning algorithms. There may be hundreds or even thousands of reasoning algorithms applied, each of which performs different analysis, e.g., comparisons, natural language analysis, lexical analysis, or the like, and generates a score. For example, some reasoning algorithms may look at the matching of terms and synonyms within the language of the input question and the found portions of the corpus of data. Other reasoning algorithms may look at temporal or spatial features in the language, while others may evaluate the source of the portion of the corpus of data and evaluate its veracity.

The scores obtained from the various reasoning algorithms indicate the extent to which the potential response is inferred by the input question based on the specific area of focus of that reasoning algorithm. Each resulting score is then weighted against a statistical model. The statistical model captures how well the reasoning algorithm performed at establishing the inference between two similar passages for a particular domain during the training period of the QA pipeline. The statistical model is used to summarize a level of confidence that the QA pipeline has regarding the evidence that the potential response, i.e. candidate answer, is inferred by the question. This process is repeated for each of the candidate answers until the QA pipeline identifies candidate answers that surface as being significantly stronger than others and thus, generates a final answer, or ranked set of answers, for the input question.

As mentioned above, QA pipeline mechanisms operate by accessing information from a corpus of data or information (also referred to as a corpus of content), analyzing it, and then generating answer results based on the analysis of this data. Accessing information from a corpus of data typically includes: a database query that answers questions about what is in a collection of structured records, and a search that delivers a collection of document links in response to a query against a collection of unstructured data (text, markup language, etc.). Conventional question answering systems are capable of generating answers based on the corpus of data and the input question, verifying answers to a collection of questions for the corpus of data, correcting errors in digital text using a corpus of data, and selecting answers to questions from a pool of potential answers, i.e. candidate answers.

Content creators, such as article authors, electronic document creators, web page authors, document database creators, and the like, determine use cases for products, solutions, and services described in such content before writing their content. Consequently, the content creators know what questions the content is intended to answer in a particular topic addressed by the content. Categorizing the questions, such as in terms of roles, type of information, tasks, or the like, associated with the question, in each document of a corpus of data allows the QA pipeline to more quickly and efficiently identify documents containing content related to a specific query. The content may also answer other questions that the content creator did not contemplate that may be useful to content users. The questions and answers may be verified by the content creator to be contained in the content for a given document. These capabilities contribute to improved accuracy, system performance, machine learning, and confidence of the QA pipeline. Content creators, automated tools, or the like, annotate or otherwise generate metadata for providing information useable by the QA pipeline to identify these question and answer attributes of the content.

Operating on such content, the QA pipeline generates answers for input questions using a plurality of intensive analysis mechanisms which evaluate the content to identify the most probable answers, i.e. candidate answers, for the input question. The most probable answers are output as a ranked listing of candidate answers ranked according to their relative scores or confidence measures calculated during evaluation of the candidate answers, as a single final answer having a highest ranking score or confidence measure, or which is a best match to the input question, or a combination of ranked listing and final answer.

FIG. 1 depicts a schematic diagram of one illustrative embodiment of a cognitive system 100 implementing a request processing pipeline 108, which in some embodiments may be a question answering (QA) pipeline, in a computer network 102. For purposes of the present description, it will be assumed that the request processing pipeline 108 is implemented as a QA pipeline that operates on structured and/or unstructured requests in the form of input questions. One example of a question processing operation which may be used in conjunction with the principles described herein is described in U.S. Patent Application Publication No. 2011/0125734, which is herein incorporated by reference in its entirety. The cognitive system 100 is implemented on one or more computing devices 104A-D (comprising one or more processors and one or more memories, and potentially any other computing device elements generally known in the art including buses, storage devices, communication interfaces, and the like) connected to the computer network 102. For purposes of illustration only, FIG. 1 depicts the cognitive system 100 being implemented on computing device 104A only, but as noted above the cognitive system 100 may be distributed across multiple computing devices, such as a plurality of computing devices 104A-D. The network 102 includes multiple computing devices 104A-D, which may operate as server computing devices, and 110-112 which may operate as client computing devices, in communication with each other and with other devices or components via one or more wired and/or wireless data communication links, where each communication link comprises one or more of wires, routers, switches, transmitters, receivers, or the like. In some illustrative embodiments, the cognitive system 100 and network 102 enables question processing and answer generation (QA) functionality for one or more cognitive system users via their respective computing devices 110-112. In other embodiments, the cognitive system 100 and network 102 may provide other types of cognitive operations including, but not limited to, request processing and cognitive response generation which may take many different forms depending upon the desired implementation, e.g., cognitive information retrieval, training/instruction of users, cognitive evaluation of data, or the like. Other embodiments of the cognitive system 100 may be used with components, systems, sub-systems, and/or devices other than those that are depicted herein.

The cognitive system 100 is configured to implement a request processing pipeline 108 that receive inputs from various sources. The requests may be posed in the form of a natural language question, natural language request for information, natural language request for the performance of a cognitive operation, or the like. For example, the cognitive system 100 receives input from the network 102, a corpus or corpora of electronic documents 106, cognitive system users, and/or other data and other possible sources of input. In one embodiment, some or all of the inputs to the cognitive system 100 are routed through the network 102. The various computing devices 104A-D on the network 102 include access points for content creators and cognitive system users. Some of the computing devices 104A-D include devices for a database storing the corpus or corpora of data 106 (which is shown as a separate entity in FIG. 1 for illustrative purposes only). Portions of the corpus or corpora of data 106 may also be provided on one or more other network attached storage devices, in one or more databases, or other computing devices not explicitly shown in FIG. 1. The network 102 includes local network connections and remote connections in various embodiments, such that the cognitive system 100 may operate in environments of any size, including local and global, e.g., the Internet.

In one embodiment, the content creator creates content in a document of the corpus or corpora of data 106 for use as part of a corpus of data with the cognitive system 100. The document includes any file, text, article, or source of data for use in the cognitive system 100. Cognitive system users access the cognitive system 100 via a network connection or an Internet connection to the network 102, and input questions/requests to the cognitive system 100 that are answered/processed based on the content in the corpus or corpora of data 106. In one embodiment, the questions/requests are formed using natural language. The cognitive system 100 parses and interprets the question/request via a pipeline 108, and provides a response to the cognitive system user, e.g., cognitive system user 110, containing one or more answers to the question posed, response to the request, results of processing the request, or the like. In some embodiments, the cognitive system 100 provides a response to users in a ranked list of candidate answers/responses while in other illustrative embodiments, the cognitive system 100 provides a single final answer/response or a combination of a final answer/response and ranked listing of other candidate answers/responses.

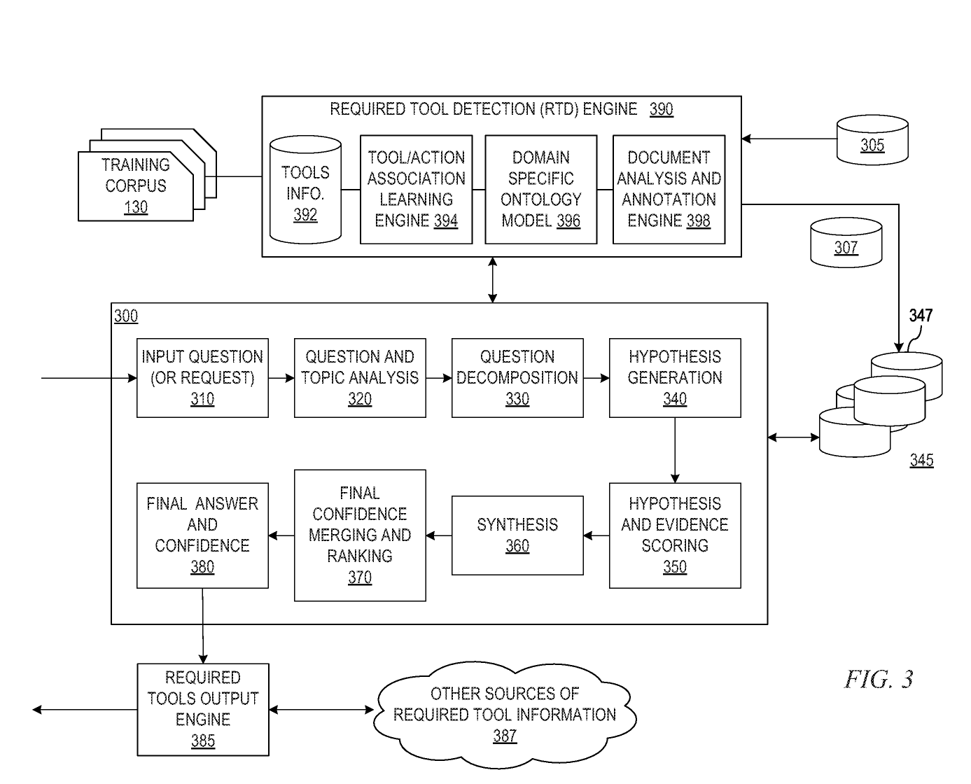

The cognitive system 100 implements the pipeline 108 which comprises a plurality of stages for processing an input question/request based on information obtained from the corpus or corpora of data 106. The pipeline 108 generates answers/responses for the input question or request based on the processing of the input question/request and the corpus or corpora of data 106. The pipeline 108 will be described in greater detail hereafter with regard to FIG. 3.

In some illustrative embodiments, the cognitive system 100 may be the IBM Watson™ cognitive system available from International Business Machines Corporation of Armonk, N.Y., which is augmented with the mechanisms of the illustrative embodiments described hereafter. As outlined previously, a pipeline of the IBM Watson™ cognitive system receives an input question or request which it then parses to extract the major features of the question/request, which in turn are then used to formulate queries that are applied to the corpus or corpora of data 106. Based on the application of the queries to the corpus or corpora of data 106, a set of hypotheses, or candidate answers/responses to the input question/request, are generated by looking across the corpus or corpora of data 106 for portions of the corpus or corpora of data 106 (hereafter referred to simply as the corpus 106) that have some potential for containing a valuable response to the input question/response (hereafter assumed to be an input question). The pipeline 108 of the IBM Watson™ cognitive system then performs deep analysis on the language of the input question and the language used in each of the portions of the corpus 106 found during the application of the queries using a variety of reasoning algorithms.

The scores obtained from the various reasoning algorithms are then weighted against a statistical model that summarizes a level of confidence that the pipeline 108 of the IBM Watson™ cognitive system 100, in this example, has regarding the evidence that the potential candidate answer is inferred by the question. This process is be repeated for each of the candidate answers to generate ranked listing of candidate answers which may then be presented to the user that submitted the input question, e.g., a user of client computing device 110, or from which a final answer is selected and presented to the user. More information about the pipeline 108 of the IBM Watson™ cognitive system 100 may be obtained, for example, from the IBM Corporation website, IBM Redbooks, and the like. For example, information about the pipeline of the IBM Watson™ cognitive system can be found in Yuan et al., “Watson and Healthcare,” IBM developerWorks, 2011 and “The Era of Cognitive Systems: An Inside Look at IBM Watson and How it Works” by Rob High, IBM Redbooks, 2012.

As noted above, while the input to the cognitive system 100 from a client device may be posed in the form of a natural language question, the illustrative embodiments are not limited to such. Rather, the input question may in fact be formatted or structured as any suitable type of request which may be parsed and analyzed using structured and/or unstructured input analysis, including but not limited to the natural language parsing and analysis mechanisms of a cognitive system such as IBM Watson™, to determine the basis upon which to perform cognitive analysis and providing a result of the cognitive analysis. The particular cognitive analysis performed may include, in accordance with the illustrative embodiments, returning a result that is responsive the structured and/or unstructured input, e.g., a request for information or a posed question, in which the results are further analyzed to identify actions described in the results and correlate those actions with particular tools required to perform those actions.

As shown in FIG. 1, the cognitive system 100 is further augmented, in accordance with the mechanisms of the illustrative embodiments, to include logic implemented in specialized hardware, software executed on hardware, or any combination of specialized hardware and software executed on hardware, for implementing a required tool detection (RTD) engine 120 that operates to analyze documents in the corpus 106 to identify tools required to perform actions specified in the documents. Having identified the required tools, this information may be used to augment the documents and provide those documents to the cognitive system 100 for use in performing a cognitive operation. In one illustrative embodiment, the required tool detection (RTD) engine 120 may operate as part of an ingestion operation for ingesting the corpus 106 into the cognitive system 100 for use in performing cognitive operations. In other illustrative embodiments the RTD engine 120 operates during runtime to augment documents returned as part of a primary search of the corpus 106 when the request processing pipeline 108 is processing queries generated from the structured and/or unstructured input from a user, e.g., an input request or question.

As shown in FIG. 1, the RTD engine 120 comprises a tools information database 122, a tool/action association learning engine 124, a domain specific ontology model 126, and a document analysis and annotation engine 128. The RTD engine 120, during a learning phase of operation, operates on training corpus 130, which may or may not be the same as corpus 106. For purpose of illustration the training corpus 130 is shown as separate from the corpus 106 and in some illustrative embodiments the training corpus 130 may be a different corpus from that of corpus 106. In some embodiments, training corpus 130 may comprise documents which are highly likely to have explicitly mentioned associations between tools and actions.

The tools information database 122 comprises information that describes various tools used for the particular domain(s) for which the RTD engine 120 is configured to operate. The tools information may comprise information identifying the tool and a description of the tool specifying characteristics of the tool. For example, the tools information database 122 may be configured as a type of tools dictionary, a list of tools from a product catalog, or the like. Entries in the tools information database 122 may include the name(s) of the tool (how the tool will appear in text), a list of synonyms for the tool, and optionally a textual description of the tool which may be provided in the tools information database 122 or otherwise added to the corpus such that it is processed along with other documents in the corpus. The tools information database 122 may be optionally configured as a taxonomy, e.g., dovetail jig is a kind of cutting guide. The way in which a tool is utilized may be discovered from the corpus in accordance with the mechanisms of the illustrative embodiments as described herein.

The tool/action association learning engine 124 utilizes natural language processing techniques to analyze the training corpus 130 during a learning phase of operation to learn associations of actions with tools, such as tools specified in the tools information database 122. The tool/action association learning engine 124, for example, may identify terms/phrases in the documents of the training corpus 130 that represent action terms/phrases, e.g., verbs or verb phrases. These action terms/phrases may be general action terms/phrases or may be specific action terms/phrases that are specific to the particular domain(s) for which the RTD engine 120 is configured. For example, in one illustrative embodiment in which the RTD engine 120 is configured to operate on a cooking domain, the action terms/phrases may be specific to cooking actions or ingredient preparation actions, e.g., boil, poach, stir, whip, blend, etc.

The RTD engine 120 may identify instances of such action terms/phrases in the content of the documents in the training corpus 130 and identify explicit mentions of tools in these documents in association with the action terms/phrases. To identify a tool that is mentioned in association with the identified action term/phrases, natural language processing techniques for determining what tool mentions in the content are associated with the identified action term/phrase may be utilized including various semantic and syntactic analysis. As a simple example, a search of a particular range of terms before and after the identified action term/phrase may be performed to identify any recognizable noun phrases that are tool names present in the range of terms and perform predicate argument structure analysis and reference resolution operations to identify associations of the action term/phrase with a noun phrase specifying a tool name explicitly mentioned in the content of the document.

For example, assume a sentence of the type “Blend broth and remaining nuts in a blender until very smooth” is present in a document of the training corpus 130. Using natural language processing techniques, it can be determined from this statement that the action term “blend” is associated with the tool “blender.” Moreover, assuming a sentence of the type “grab your saw and cut the wood with it” in a document of the training corpus, reference resolution may be employed to determine what the term “it” refers to and in so doing determining that the action term “cut” is associated with the tool “saw.”

In addition to identifying the association of the action term/phrase with a tool name, the natural language processing may further identify the object of the action and associate that object with the action and the tool. For example, in the sentence “grab your saw and cut the wood with it”, the natural language processing produces information associating action=cut, tool=saw, and object=wood. In the case of the sentence “Blend broth and remaining nuts in a blender until very smooth,” natural language processing may identify the action=blend, the tool=blender, and the object=broth. A second association may also be generated that associates action=blend, tool=blender, and object=nuts. Alternatively, the tool/action association learning engine 124 may be provided with domain knowledge about actions to inform the tool/action association learning engine 124 of the number of objects that particular actions require, e.g., the action of “blend” may require 2 or more objects. Moreover, the determination of the number of objects to associate with an action may be determined from standard verb lexical resources, such as FrameNet. For example, the tuple of blend/blender/food may be valid with one object but a joining action may require co-themes, e.g., join/carriage bolt/rail/bracket.

It should be appreciated that there may be many different types of natural language processing techniques that may be implemented by the tool/action association learning engine 124 to identify associations of action terms with noun phrases. The illustrative embodiments leverage such natural language processing techniques specifically for the identification to required tools for performing domains specific actions. The particular required tools that may be identified may be specified in the tools information database 122 and the information in the tools information database 122 may be linked or otherwise associated with instances of required tools identified in content of documents in the training corpus 130 and/or corpus 106 during runtime operation as discussed hereafter.

The tool/action association learning engine 124 generates tuples of information where these tuples associate action terms/phrases with required tools for performing those actions. In some embodiments, the tuple further includes a confidence level or score indicating the confidence the tool/action association learning engine 124 has that the action term/phrase is associated with the required tool. This confidence level or score may be calculated in many different ways depending on the desired implementation. In one simple embodiment, the confidence level or score may be calculated based on a number of occurrences of the association of the action term/phrase, or its synonyms, with the required tool in the documents of the training corpus 130. In other illustrative embodiments, the confidence score may be calculated based on a statistical measure of instances of the action term/phrase and required tool found in the documents of the training corpus 130, e.g., inverse document frequency (IDF). In still other illustrative embodiments, a measure of the reliability of a heuristic used to generate the action term/phrase and required tool association may be used as a basis for calculating a confidence level. In still other illustrative embodiments, a reputation score associated with a source document from which the tuple is generated may be used as a basis for calculating the confidence score for the tuple, e.g., the confidence of a tuple is boosted when it is found from an expert blog versus an unrecognized (new) forum post question. Of course any combination of these techniques may also be utilized. Moreover, other techniques for calculating a confidence in the association may be used without departing from the spirit and scope of the illustrative embodiments.

In some illustrative embodiments, the tuple may comprise a 3-tuple of the type {action, required tool, confidence level}. However, it should be appreciated that the action and required tool specified in such a tuple may not be appropriate for all instances of the action. That is, depending on what the action is being performed on, i.e. the object of the action, different required tools may be utilized. For example, taking as an example the action term “blend”, a “blender” tool is appropriate in cases where the object upon which the “blend” action is performed is in a liquid state or can be rendered into a liquid state. For example, if the object is a mixture of broth and nuts, then the required tool of a “blender” is appropriate. However, if the blend action is being performed on a particulate object, then a blender is not the appropriate required tool, e.g., when blending salt with paprika, one would not use a blender and instead may use a wooden spoon. Thus, in order to distinguish between different instances of action terms operating on different types of objects, and to provide a basis for identifying required tools for action terms operating on similar objects in contents of documents of a corpus 106, the tuple may be extended to a 4-tuple that includes the object upon which the action is performed, e.g., {action, required tool, object, confidence level}.

In such an embodiment, because the tuple contains not only the action and required tool, but also the object, when applied to tagged or annotated text of a corpus 106, the mechanisms of the RTD engine 120 are able to infer the correct tool even though the surface action term/phrase, e.g., verb, may be the same. For example, with the sentence “Blend milk and remaining berries” may be annotated or augmented with required tool information indicating a “blender” while the sentence “Blend the spices with the remaining dry ingredients” may be annotated or augmented with required tool information specifying a “spoon.”

The tool/action association learning engine 124 extends the use of natural language processing techniques, and the tuple generation described above, in a number of different ways specific to the identification of required tools for action terms/phrases. In particular, the tool/action association learning engine 124 looks for required tool specific natural language constructions to find additional tuples that may be added to the set of tuples found in the training corpus 130 based on predicate argument structure analysis and reference resolution analysis. In one illustrative embodiment, the tool/action association learning engine 124 may implement logic to perform a morphological similarity analysis which identifies action terms and entities specified in the natural language content that have an overlapping or identical stem. For example, in the sentence “Saw crown molding making sure that the miter saw is at a 45 degree angle,” the action term “saw” and the required tool “miter saw” have overlap in the term “saw” which is indicative of the text “miter saw” being directed to a tool required to perform the action “saw.”

In another illustrative embodiment, the tool/action association learning engine 124 may implement logic to perform a posteriori tool mention analysis based on the order of actions indicated in the content of the document. That is, the a posteriori tool mention analysis identifies instances of text in documents of the training corpus 130 where the tool used to perform a certain action on an object is mentioned later in the text after the action is completed in the ordered series of instructions specifying actions to perform a task. For example, a first sentence in content of a document of the training corpus 130 may state to “bake the cake at 450 degrees” and a later sentence may be of the type “take the cake out of the oven.” The second sentence implies that the cake was baked in the oven and thus, the required tool of an “oven” is associated with the action term “bake.”

In yet another illustrative embodiment, the tool/action association learning engine 124 may implement logic to perform required tool specific prepositional phrase attachment analysis. The required tool specific prepositional phrase attachment analysis matches candidate mentions of required tools that a syntax analysis attaches to an action term/phrase previously found to require a tool. For example, the concept “glue” typically would not be labeled as a tool in most lexicons. However, in response to the mechanisms of the illustrative embodiments encounter a sentence such as “attach the paper with the glue,” the illustrative embodiments generate a tuple of {attach, glue, paper, confidence level} because the action term “attach” has been seen to require a tool in previous examples. That is, in other sentences, the action term “attach” has been identified and correlated with other types of required tools and thus, the action term “attach” is identified as one that requires a tool to accomplish the action. When encountering the action term “attach” in the sentence “attach the paper with the glue”, it is known that the term “attach” requires a tool and thus, the sentence is analyzed to identify the tool which, in this case is the “glue” with the “paper” being the object of the action.

In another illustrative embodiment, the tool/action association learning engine 124 may implement logic to perform “using” action coordination. That is, candidate nouns or noun phrases that are a direct object of the term “use” or a synonym of the term “use”, that is coordinated with an action term/phrase, may be identified as a required tool for performing the action. For example, in the sentence “Using a mallet, crush the almonds”, the noun “mallet” is a direct object of the term “using” which is coordinated with the action term “crush” on the object “almonds.” The mechanisms of the tool/action association learning engine 124 may identify such instances in content of the documents of the training corpus 130 and may identify additional tuples matching such patterns, e.g., in the example above, the 4-tuple of {crush, mallet, almonds, confidence level} may be generated.

In yet another illustrative embodiment, the tool/action association learning engine 124 may implement logic to identify particular predefined patterns of text that are directed to specific references to required tools for performing an action. For example, a predetermined set of patterns may be generated and stored in association with the tool/action association learning engine 394 and these patterns may be used to match patterns of text in the documents of the training corpus 130. For example, a pattern construct of the type “TOOL is <neutral or positive sentiment adjective> for ACTION” may be defined and used to identify instances of this pattern in content of documents of the training corpus 130. Thus, for example, a sentence of the type “Glue is good for attaching the paper” will match this pattern and thus, the tools, object, and action may be extracted from the sentence in accordance with the pattern, e.g., a tuple of the type {attaching, glue, paper, confidence level} is generated. Sentences having negative sentiment may not match this pattern, e.g., “hammers are bad for gluing paper.”

The tuples generated by the tool/action association learning engine 124 based on the analysis of the training corpus 130 using the tools information database 122 information, in one or more of the ways previously described above, may be filtered by the tool/action association learning engine 124 to remove false positives caused by particular types of language constructions. In particular one filter may be to identify tuples generated from sentences where the required tool is the direct object of an action. For example, in the sentence “I used an old chair leg for this project” the candidate tool is a “chair leg,” the object is “project” and the action term is “used”. Such tuples are problematic as they do not provide any specific knowledge of required tools for domain specific actions and are too general to be of use. Thus, various filters may be applied, such as this direct object filter, to eliminate false positive tuples present in the tuples generated by the tool/action association learning engine 124.

The resulting set of tuples generated by the tool/action association learning engine 124 may be used to train a domain specific ontology model 126 to recognize such tuples in other documents. For example, the ontology model may be trained by representing the associations of actions with required tools and objects, as well as similar actions/tools/objects, synonyms of these actions, and the like. The ontology model may implement a hierarchical model that represents parent-child relationships between related concepts.

In one illustrative embodiment, the training of the domain specific ontology model 126 may be based on the expectation that the same tuples are expected to be encountered in the corpus multiple times. The more a tuple is identified from documents of the corpus, the more confidence that the tool is required for the corresponding action because they are more strongly correlated. Thus, the tool/action association learning engine 124 can establish a confidence score or rating from how often a tuple is identified in the corpus. This confidence score or rating can also be tempered via various mechanisms. For example, the tempering may involve a difference between the total frequency of a tuple in the corpus and an inverse document frequency of the tuple. That is, the tool/action association learning engine 124 may weigh the frequency a tuple occurs against the frequency of the individual words in the corpus. For example, if “to pound” is very common as well as “nail,” then the tuple {pound, nail} would have a higher confidence score than other tuples such as {countersink, bolt}. This information may be learned from the processing of the corpus and used to generate/train the domain specific ontology model 126

The trained domain specific ontology model 126 may be used by the document analysis and annotation engine 128, during a second phase of operation of the required tool detection engine 120, to analyze and annotate documents in the corpus 106 with required tool information based on the trained domain specific ontology model 126. The document analysis and annotation engine 128 may analyze content of documents, such as may be done as part of an ingestion operation for ingesting the corpus 106 for use by the cognitive system 100, and annotate the documents with {action, tool} tuples, {action, tool, object} tuples, or the like, using the trained domains specific ontology model 126.

For example, in one illustrative embodiment, given an action/object pair identified in content of a document in the corpus 106, the document analysis and annotation engine 128 applying the trained domain specific ontology model 126, returns 0 or more required tools with a confidence rating corresponding to the confidence rating. In some illustrative embodiments, the confidence rating may be a probability mass spread over possible tools for the current action/object pair or may be calculated based on other reasoning such as the system's confidence in how well it is tracking the overall project steps with regard to the particular goal of the project. For example, the system may determine a confidence that the project is attempting to achieve a particular outcome and thus, identifies tools that are consistent with the projects of the identified type, e.g., high confidence that the project is a chair-construction project and thus, the system will suggest tools found in other chair-construction documents.

This may be done with each action term/phrase identified in the documents of the corpus 106. The resulting returned tuples may be used to annotate the document to thereby specify for each action a tool required by that action. The resulting annotated document may be stored in the corpus 106 or may otherwise be provided to the cognitive system 100 for use by the request processing pipeline 108 of the cognitive system 100.

As noted above, the illustrative embodiments may differentiate ambiguous situations where the required tool is unmentioned in the content of the document. For example, in a cooking domain, a sentence of the type “Blend milk and remaining berries” which requires a blender to accomplish may be differentiated from “Blend the spices with the remaining dry ingredients” which can be done using a spoon and would not normally be done using a blender. As another example, consider a sentence of the type “Countersink the deck screws into the arm assembly.” The mechanisms of the document analysis and annotation engine 128 of the RTD engine 120 look up the tuples in the trained domain specific ontology model 126 for “countersink/deck screws/?” and find the tool(s) to be used in this case (drill with countersink bit). Alternatively if the tuple with “deck screw” is not found, a parent class of “deck screws” in the domain specific ontology model 126 may be utilized to attempt to find an applicable tuple. Alternatively, analysis of all of the tuples of the particular action may be performed to identify whether all tuples use the same required tool, then that required tool may be returned as a required tool for the action specified in the sentence.

As mentioned above, the operation of the document analysis and annotation engine 128 may be implemented as part of an ingestion operation for ingesting the corpus 106 into the cognitive system 100 for use by the request processing pipeline 108. The annotated documents of the ingested corpus 106 may then be used by the request processing pipeline 108 to generate responses/answers to input requests/questions. The response/answer may include information specifying the required tools for performing actions specified in the documents used as a basis for generating the response/answer. For example, if a user submits a request/question directed to finding a recipe in a cooking domain, the request processing pipeline 108 may return a recipe meeting the criteria specified in the request/question based on documents in the corpus 106. The response/answer may comprise the recipe as generated from the corpus 106 along with information specifying the required tools for performing actions in the recipe. The required tools information may be obtained from the annotations generated by the mechanisms of the RTD engine 120 as discussed above.

In other illustrative embodiments, the document analysis and annotation engine 128 may operation during runtime operation of the cognitive system 100 and processing of an input request/question from a user via their client device 110. With these illustrative embodiments, the primary difference is that the documents in the corpus 106 may not be annotated with required tools information during ingestion of the corpus 106 and the annotations may be generated dynamically in response to a document being selected for use in generating an response/answer to a user's request/question. Thus, a document that is the basis for a response/answer may be submitted to the document analysis and annotation engine 128 in response to the document being selected as a basis for a response/answer to the user request/question. The document analysis and annotation engine 128 may then return the annotated document to the cognitive system 100 for use in presenting the response/answer to the user so as to include required tool information in the response/answer.

In either case, in some illustrative embodiments, the cognitive system 100 is further augmented to include a required tools output engine 140. The required tools output engine 140 provides additional logic and functionality for presenting required tools information in the response/answer output by the cognitive system 100 to the user's client device 110 as a response/answer to the user's input request/question. The particular output generated by the required tools output engine 140 depends on the embodiment but in general formats and presents the required tool information for presentation to the user and, in some cases, links the presentation of required tool information to other sources of information present on one or more computing devices of the network 102. For example, in some illustrative embodiments, the required tools output engine 140 may generate a “What you'll need” section of the response/answer that lists the required tools that are required to perform actions indicated in the response/answer. The listing of required tools in the “What you'll need” section of the response may have links to the actions specified in the response/answer where the required tool is required to perform the action.

In other illustrative embodiments, the required tools output engine 140 may take the required tools information and search for listings of tools matching the required tools on one or more computing systems associated with providers of such tools or providers of information about such tools. For example, retailers and other organizations that provide such tools may have associated websites and the required tools output engine 140 may search these websites for entries corresponding to the required tools, e.g., if a blender is required for an action, an appliance retailer website may be searched for entries for blenders that would be able to be used to perform the action. Links or advertisements corresponding to the information found on these other computing devices may be returned to the user as part of the required tools listing in the response/answer. In some embodiments, these advertisements or links to information from retailers may be presented to the user in response to the user selecting an option to have such information displayed, e.g., a user interface element of the response/answer output that indicates that the user needs to obtain the required tool.

As another example embodiment, the mechanisms of the illustrative embodiments may be used as part of a content filtering mechanism, such as in combination with a search engine or the like. That is, a user may configure a profile indicating the tools that the user has available. The mechanisms of the illustrative embodiments may be used to identify the tools required to perform various projects and identify those projects for which the user has the required tools to successfully complete the tasks of the project. As an example, a recipe website may be provided with a search engine for a user to input a set of search criteria for the recipes that they are interested in. In addition, the user may select which cooking tools that the user has access to, or may otherwise establish a profile with the website indicating what tools they have access to, e.g., the user may specify that they have access to a blender. The search engine of the website may identify the recipes meeting the search criteria and may perform a further filtering of these recipes based on the analysis of the recipes to identify what tools are required to achieve the tasks of the recipe in accordance with one or more of the illustrative embodiments, and identify those recipes for which the user has the required tools. For example, if the user is on a woodworking website but does not have access to a dovetail jig, then when the search for cabinetry projects is done, the mechanisms of the illustrative embodiments would not show those projects that require making dovetails. Of course, this illustrative embodiment may be combined with other illustrative embodiments as well, e.g., advertisements for the tools that the user is missing or does not have access to may be presented to the user while advertisements for other tools that the user has access to may not be presented.

Thus, the illustrative embodiments provide mechanisms for automatically determining what tools are required to perform actions specified in documents of a corpus and annotating those documents to include the required tools information. This is especially useful in domains where the results/answers generated by a cognitive system are essentially listings of instructions having actions for performing a task. Examples of such domains include the cooking domain, home repair and do-it-yourself type domains, medical procedure domain, scientific experimentation and research domain, and a plethora of other domains. It should be appreciated that while the above examples utilize examples of tools that are physical tools, the tools may in fact be virtual tools, such as software based tools executed in computing devices. The tools may be of various types of physical and/or virtual tools depending on the particular domain.

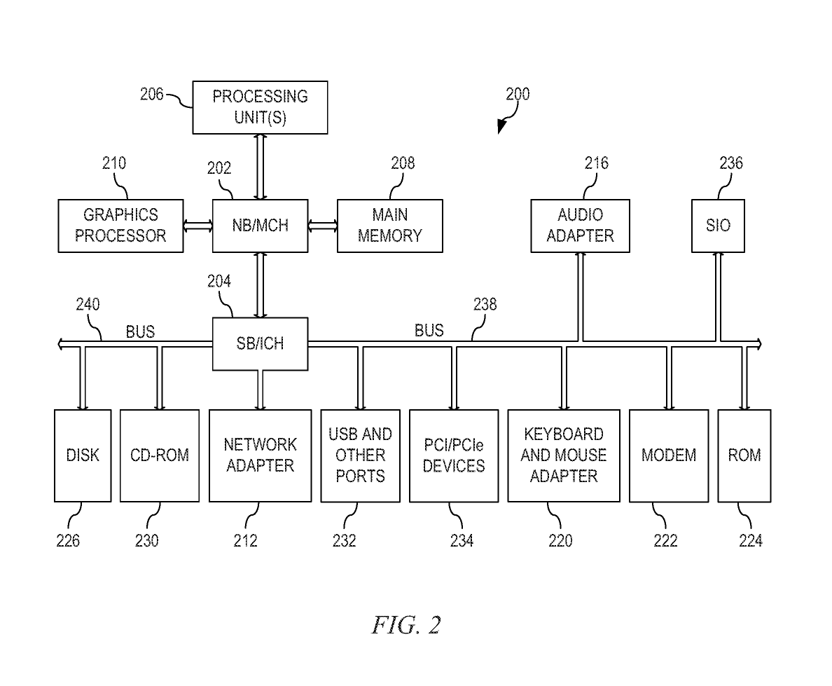

As noted above, the mechanisms of the illustrative embodiments are rooted in the computer technology arts and are implemented using logic present in such computing or data processing systems. These computing or data processing systems are specifically configured, either through hardware, software, or a combination of hardware and software, to implement the various operations described above. As such, FIG. 2 is provided as an example of one type of data processing system in which aspects of the present invention may be implemented. Many other types of data processing systems may be likewise configured to specifically implement the mechanisms of the illustrative embodiments.

FIG. 2 is a block diagram of an example data processing system in which aspects of the illustrative embodiments are implemented. Data processing system 200 is an example of a computer, such as server 104 or client 110 in FIG. 1, in which computer usable code or instructions implementing the processes for illustrative embodiments of the present invention are located. In one illustrative embodiment, FIG. 2 represents a server computing device, such as a server 104, which, which implements a cognitive system 100 and QA system pipeline 108 augmented to include the additional mechanisms of the illustrative embodiments described hereafter.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 is connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 is connected to SB/ICH 204.

An operating system runs on processing unit 206. The operating system coordinates and provides control of various components within the data processing system 200 in FIG. 2. As a client, the operating system is a commercially available operating system such as Microsoft® Windows 8®. An object-oriented programming system, such as the Java™ programming system, may run in conjunction with the operating system and provides calls to the operating system from Java™ programs or applications executing on data processing system 200.

As a server, data processing system 200 may be, for example, an IBM® eServer™ System p® computer system, running the Advanced Interactive Executive (AIX®) operating system or the LINUX® operating system. Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and are loaded into main memory 208 for execution by processing unit 206. The processes for illustrative embodiments of the present invention are performed by processing unit 206 using computer usable program code, which is located in a memory such as, for example, main memory 208, ROM 224, or in one or more peripheral devices 226 and 230, for example.

A bus system, such as bus 238 or bus 240 as shown in FIG. 2, is comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, includes one or more devices used to transmit and receive data. A memory may be, for example, main memory 208, ROM 224, or a cache such as found in NB/MCH 202 in FIG. 2.

Those of ordinary skill in the art will appreciate that the hardware depicted in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device that is configured with flash memory to provide non-volatile memory for storing operating system files and/or user-generated data, for example. Essentially, data processing system 200 may be any known or later developed data processing system without architectural limitation.

FIG. 3 illustrates an example of a cognitive system processing pipeline which, in the depicted example, is a question and answer (QA) system pipeline used to process an input question in accordance with one illustrative embodiment. As noted above, the cognitive systems with which the illustrative embodiments may be utilized are not limited to QA systems and thus, not limited to the use of a QA system pipeline. FIG. 3 is provided only as one example of the processing structure that may be implemented to process a natural language input requesting the operation of a cognitive system to present a response or result to the natural language input.

The QA system pipeline of FIG. 3 may be implemented, for example, as QA pipeline 108 of cognitive system 100 in FIG. 1. It should be appreciated that the stages of the QA pipeline shown in FIG. 3 are implemented as one or more software engines, components, or the like, which are configured with logic for implementing the functionality attributed to the particular stage. Each stage is implemented using one or more of such software engines, components or the like. The software engines, components, etc. are executed on one or more processors of one or more data processing systems or devices and utilize or operate on data stored in one or more data storage devices, memories, or the like, on one or more of the data processing systems. The QA pipeline of FIG. 3 is augmented, for example, in one or more of the stages to implement the improved mechanism of the illustrative embodiments described hereafter, additional stages may be provided to implement the improved mechanism, or separate logic from the pipeline 300 may be provided for interfacing with the pipeline 300 and implementing the improved functionality and operations of the illustrative embodiments.

As shown in FIG. 3, the QA pipeline 300 comprises a plurality of stages 310-380 through which the cognitive system operates to analyze an input question and generate a final response. In an initial question input stage 310, the QA pipeline 300 receives an input question that is presented in a natural language format. That is, a user inputs, via a user interface, an input question for which the user wishes to obtain an answer, e.g., “Who are Washington's closest advisors?” In response to receiving the input question, the next stage of the QA pipeline 300, i.e. the question and topic analysis stage 320, parses the input question using natural language processing (NLP) techniques to extract major features from the input question, and classify the major features according to types, e.g., names, dates, or any of a plethora of other defined topics. For example, in the example question above, the term “who” may be associated with a topic for “persons” indicating that the identity of a person is being sought, “Washington” may be identified as a proper name of a person with which the question is associated, “closest” may be identified as a word indicative of proximity or relationship, and “advisors” may be indicative of a noun or other language topic.

In addition, the extracted major features include key words and phrases classified into question characteristics, such as the focus of the question, the lexical answer type (LAT) of the question, and the like. As referred to herein, a lexical answer type (LAT) is a word in, or a word inferred from, the input question that indicates the type of the answer, independent of assigning semantics to that word. For example, in the question “What maneuver was invented in the 1500s to speed up the game and involves two pieces of the same color?,” the LAT is the string “maneuver.” The focus of a question is the part of the question that, if replaced by the answer, makes the question a standalone statement. For example, in the question “What drug has been shown to relieve the symptoms of ADD with relatively few side effects?,” the focus is “drug” since if this word were replaced with the answer, e.g., the answer “Adderall” can be used to replace the term “drug” to generate the sentence “Adderall has been shown to relieve the symptoms of ADD with relatively few side effects.” The focus often, but not always, contains the LAT. On the other hand, in many cases it is not possible to infer a meaningful LAT from the focus.

Referring again to FIG. 3, the identified major features are then used during the question decomposition stage 330 to decompose the question into one or more queries that are applied to the corpora of data/information 345 in order to generate one or more hypotheses. The queries are generated in any known or later developed query language, such as the Structure Query Language (SQL), or the like. The queries are applied to one or more databases storing information about the electronic texts, documents, articles, websites, and the like, that make up the corpora of data/information 345. That is, these various sources themselves, different collections of sources, and the like, represent a different corpus 347 within the corpora 345. There may be different corpora 347 defined for different collections of documents based on various criteria depending upon the particular implementation. For example, different corpora may be established for different topics, subject matter categories, sources of information, or the like. As one example, a first corpus may be associated with healthcare documents while a second corpus may be associated with financial documents. Alternatively, one corpus may be documents published by the U.S. Department of Energy while another corpus may be IBM Redbooks documents. Any collection of content having some similar attribute may be considered to be a corpus 347 within the corpora 345.

The queries are applied to one or more databases storing information about the electronic texts, documents, articles, websites, and the like, that make up the corpus of data/information, e.g., the corpus of data 106 in FIG. 1. The queries are applied to the corpus of data/information at the hypothesis generation stage 340 to generate results identifying potential hypotheses for answering the input question, which can then be evaluated. That is, the application of the queries results in the extraction of portions of the corpus of data/information matching the criteria of the particular query. These portions of the corpus are then analyzed and used, during the hypothesis generation stage 340, to generate hypotheses for answering the input question. These hypotheses are also referred to herein as “candidate answers” for the input question. For any input question, at this stage 340, there may be hundreds of hypotheses or candidate answers generated that may need to be evaluated.

The QA pipeline 300, in stage 350, then performs a deep analysis and comparison of the language of the input question and the language of each hypothesis or “candidate answer,” as well as performs evidence scoring to evaluate the likelihood that the particular hypothesis is a correct answer for the input question. As mentioned above, this involves using a plurality of reasoning algorithms, each performing a separate type of analysis of the language of the input question and/or content of the corpus that provides evidence in support of, or not in support of, the hypothesis. Each reasoning algorithm generates a score based on the analysis it performs which indicates a measure of relevance of the individual portions of the corpus of data/information extracted by application of the queries as well as a measure of the correctness of the corresponding hypothesis, i.e. a measure of confidence in the hypothesis. There are various ways of generating such scores depending upon the particular analysis being performed. In generally, however, these algorithms look for particular terms, phrases, or patterns of text that are indicative of terms, phrases, or patterns of interest and determine a degree of matching with higher degrees of matching being given relatively higher scores than lower degrees of matching.

Thus, for example, an algorithm may be configured to look for the exact term from an input question or synonyms to that term in the input question, e.g., the exact term or synonyms for the term “movie,” and generate a score based on a frequency of use of these exact terms or synonyms. In such a case, exact matches will be given the highest scores, while synonyms may be given lower scores based on a relative ranking of the synonyms as may be specified by a subject matter expert (person with knowledge of the particular domain and terminology used) or automatically determined from frequency of use of the synonym in the corpus corresponding to the domain. Thus, for example, an exact match of the term “movie” in content of the corpus (also referred to as evidence, or evidence passages) is given a highest score. A synonym of movie, such as “motion picture” may be given a lower score but still higher than a synonym of the type “film” or “moving picture show.” Instances of the exact matches and synonyms for each evidence passage may be compiled and used in a quantitative function to generate a score for the degree of matching of the evidence passage to the input question.

Thus, for example, a hypothesis or candidate answer to the input question of “What was the first movie?” is “The Horse in Motion.” If the evidence passage contains the statements “The first motion picture ever made was ‘The Horse in Motion’ in 1878 by Eadweard Muybridge. It was a movie of a horse running,” and the algorithm is looking for exact matches or synonyms to the focus of the input question, i.e. “movie,” then an exact match of “movie” is found in the second sentence of the evidence passage and a highly scored synonym to “movie,” i.e. “motion picture,” is found in the first sentence of the evidence passage. This may be combined with further analysis of the evidence passage to identify that the text of the candidate answer is present in the evidence passage as well, i.e. “The Horse in Motion.” These factors may be combined to give this evidence passage a relatively high score as supporting evidence for the candidate answer “The Horse in Motion” being a correct answer.

It should be appreciated that this is just one simple example of how scoring can be performed. Many other algorithms of various complexity may be used to generate scores for candidate answers and evidence without departing from the spirit and scope of the present invention.

In the synthesis stage 360, the large number of scores generated by the various reasoning algorithms are synthesized into confidence scores or confidence measures for the various hypotheses. This process involves applying weights to the various scores, where the weights have been determined through training of the statistical model employed by the QA pipeline 300 and/or dynamically updated. For example, the weights for scores generated by algorithms that identify exactly matching terms and synonym may be set relatively higher than other algorithms that are evaluating publication dates for evidence passages. The weights themselves may be specified by subject matter experts or learned through machine learning processes that evaluate the significance of characteristics evidence passages and their relative importance to overall candidate answer generation.

The weighted scores are processed in accordance with a statistical model generated through training of the QA pipeline 300 that identifies a manner by which these scores may be combined to generate a confidence score or measure for the individual hypotheses or candidate answers. This confidence score or measure summarizes the level of confidence that the QA pipeline 300 has about the evidence that the candidate answer is inferred by the input question, i.e. that the candidate answer is the correct answer for the input question.

The resulting confidence scores or measures are processed by a final confidence merging and ranking stage 370 which compares the confidence scores and measures to each other, compares them against predetermined thresholds, or performs any other analysis on the confidence scores to determine which hypotheses/candidate answers are the most likely to be the correct answer to the input question. The hypotheses/candidate answers are ranked according to these comparisons to generate a ranked listing of hypotheses/candidate answers (hereafter simply referred to as “candidate answers”). From the ranked listing of candidate answers, at stage 380, a final answer and confidence score, or final set of candidate answers and confidence scores, are generated and output to the submitter of the original input question via a graphical user interface or other mechanism for outputting information.

As shown in FIG. 3, in accordance with one illustrative embodiment, the pipeline 300 operates with the RTD engine 390 to obtain required tools information for a response/answer generated by the pipeline 300 in response to the input question or request 310. The RTD engine 390 comprises elements 392-398 which are similar to the elements 122-128 in FIG. 1 and perform similar operations as noted above. The RTD engine 390 is trained using the training corpus 130 as discussed previously. The RTD engine 390 may receive an initial corpus 305, such as part of an ingestion operation for ingesting the corpus 305, and may generate an annotated corpus 307 that is annotated with required tool information and which is added to the corpora 345 that are used by the pipeline 300. Alternatively, the pipeline 300 may generate a response/answer to the input question/request 310 and may send the documents associated with the response/answer to the RTD engine 390 for required tool annotation. The RTD engine 390 returns the annotated document(s) to the pipeline 300 which may then utilize the required tool information to generate an output of the response/answer that includes the required tool information, such as part of stage 380. The response/answer may be provided to the required tools output engine 385 which may search other sources of required tool information 387, such as retailers and other providers of such tools, and may generate an output that includes links or advertisements based on the information from these other sources 387. The output is provided to the user via the client computing device as a response/answer to their input question/request 310.

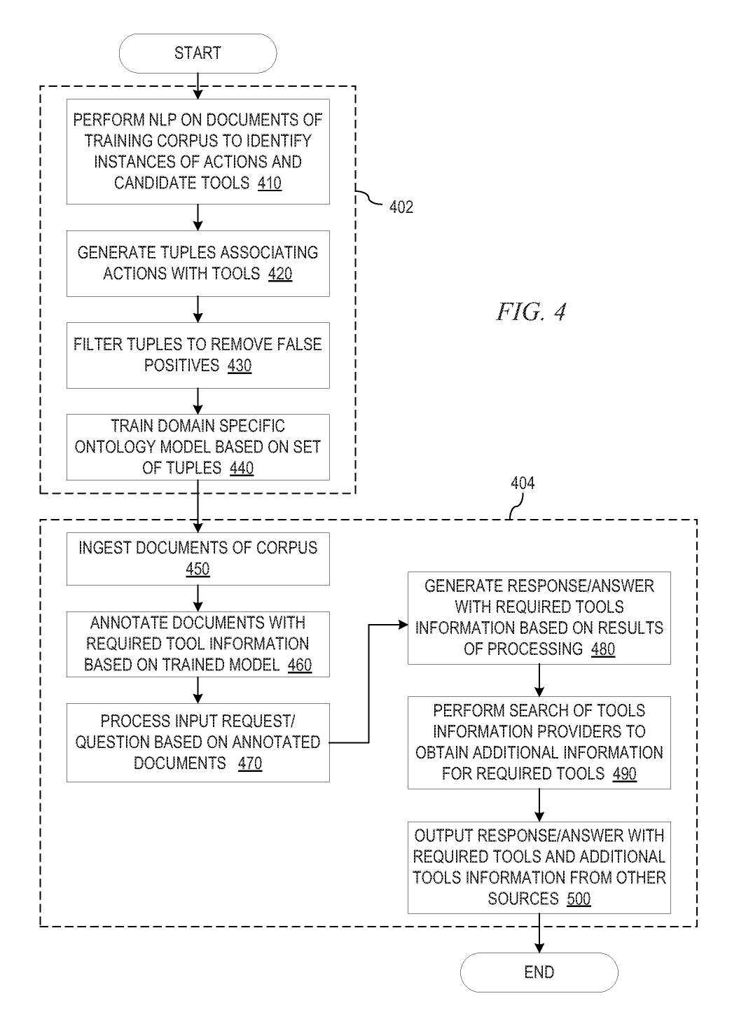

FIG. 4 is a flowchart outlining an example operation for automatically detecting required tools for performing a task and generating a cognitive response to an input request based on the detected required tools in accordance with one illustrative embodiment. As shown in FIG. 4, the operation starts by performing natural language processing (NLP) on documents of a training corpus to identify instances of actions and candidate tools for performing those actions (step 410). Tuples are generated that associate the actions with tolls based on the identified instances (step 420). The tuples that are generated are then filtered to remove any false positives and thereby generate a final set of tuples (step 430). The final set of tuples are then used to train a domain specific ontology model (step 440). Steps 410-440 are performed as part of a first phase of operation, i.e. a learning phase, in which the RTD engine learns the associations between actions and required tools, as well as optionally also associated with objects upon which the actions are performed by that required tool.

During a second phrase 404, a runtime operation in which the learned associations of actions and required tools as set forth in the trained domain specific ontology model are used to perform operations for generating responses/answers to input requests/questions. As shown in FIG. 4, documents of a corpus are ingested (step 450) and annotated with required tool information based on an application of the trained model to the contents of those documents (step 460). A received input request/question is processed based on the annotated documents (step 470) to generate a response/answer with required tools information (step 480). Optionally, a search of tools information providers, or tools providers, may be performed to obtain additional information for the required tools (step 490). An output of the response/answer with the required tools information, and optionally the additional tools information from other sources, is generated and output to the originator of the input request/question (step 500). The operation then terminates.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a communication bus, such as a system bus, for example. The memory elements can include local memory employed during actual execution of the program code, bulk storage, and cache memories which provide temporary storage of at least some program code in order to reduce the number of times code must be retrieved from bulk storage during execution. The memory may be of various types including, but not limited to, ROM, PROM, EPROM, EEPROM, DRAM, SRAM, Flash memory, solid state memory, and the like.

Input/output or I/O devices (including but not limited to keyboards, displays, pointing devices, etc.) can be coupled to the system either directly or through intervening wired or wireless I/O interfaces and/or controllers, or the like. I/O devices may take many different forms other than conventional keyboards, displays, pointing devices, and the like, such as for example communication devices coupled through wired or wireless connections including, but not limited to, smart phones, tablet computers, touch screen devices, voice recognition devices, and the like. Any known or later developed I/O device is intended to be within the scope of the illustrative embodiments.

Network adapters may also be coupled to the system to enable the data processing system to become coupled to other data processing systems or remote printers or storage devices through intervening private or public networks. Modems, cable modems and Ethernet cards are just a few of the currently available types of network adapters for wired communications. Wireless communication based network adapters may also be utilized including, but not limited to, 802.11 a/b/g/n wireless communication adapters, Bluetooth wireless adapters, and the like. Any known or later developed network adapters are intended to be within the spirit and scope of the present invention.

The description of the present invention has been presented for purposes of illustration and description, and is not intended to be exhaustive or limited to the invention in the form disclosed. Many modifications and variations will be apparent to those of ordinary skill in the art without departing from the scope and spirit of the described embodiments. The embodiment was chosen and described in order to best explain the principles of the invention, the practical application, and to enable others of ordinary skill in the art to understand the invention for various embodiments with various modifications as are suited to the particular use contemplated. The terminology used herein was chosen to best explain the principles of the embodiments, the practical application or technical improvement over technologies found in the marketplace, or to enable others of ordinary skill in the art to understand the embodiments disclosed herein.

1. A method, in a data processing system comprising a processor and a memory, wherein the memory comprises instructions executed by the processor to cause the processor to implement the method, comprising:
performing, by the data processing system, natural language processing of content of a training corpus of electronic documents to identify associations of action terms with required tools for performing actions corresponding to the action terms;
training, by the data processing system, an ontology model based on the identified associations of the action terms with required tools for performing actions corresponding to the action terms;
performing, by the data processing system, analysis of electronic documents of one or more other corpora based on the trained ontology model to identify required tools for performing actions specified in the electronic documents; and
annotating, by the data processing system, one or more of the electronic documents of the one or more other corpora to include required tools annotation metadata identifying tools required to perform actions corresponding to action terms present in the one or more electronic documents to thereby generate at least one updated corpus.

2. The method of claim 1, wherein at least one electronic document of the one or more other corpora does not explicitly indicate, in content of the electronic document, a tool to perform a task specified in the content of the electronic document, and wherein performing analysis of electronic documents of one or more other corpora based on the trained ontology model comprises associating a tool with the task based on at least one action term specified in the content of the electronic document in association with the task.

3. The method of claim 1, wherein performing natural language processing of content of a training corpus comprises performing a morphological similarity analysis that identifies action terms and entities specified in natural language content of the training corpus that have an overlapping stem.

4. The method of claim 1, wherein performing natural language processing of content of a training corpus comprises performing a posteriori tool mention analysis which identifies text in the content of the training corpus where a tool required to perform an action corresponding to an action term in the text is present in the text after an instance of the action term corresponding to the action.

5. The method of claim 1, wherein the ontology model comprises a plurality of tuples, wherein each tuple associates an action term with a corresponding tool for performing an action corresponding to the action term, and wherein performing analysis of electronic documents of one or more other corpora based on the trained ontology model to identify required tools for performing actions specified in the electronic documents comprises matching action terms in the electronic documents with action terms in tuples of the plurality of tuples.

6. The method of claim 5, wherein each tuple further associates the action term and corresponding tool with at least one of an object upon which the action is performed or a confidence score indicating a confidence that the corresponding tool is required to perform an action corresponding to the action term.

7. The method of claim 6, wherein the confidence score is calculated by the data processing system based on a function of a frequency of occurrence of the tuple present in the training corpus.

8. The method of claim 1, wherein performing natural language processing of content of a training corpus comprises:
applying one or more pre-defined textual patterns to the content of the training corpus, wherein each pre-defined textual pattern specifies a mention of a tool name and an action term;
identifying matching portions of text in the content of the training corpus that match one or more of the pre-defined textual patterns; and
extracting, from the matching portions of text, a tool name and action term.

9. The method of claim 1, further comprising:
receiving, by the data processing system from a user computing device, a request for a project to be performed by the user;
performing, by the data processing system, a search of the updated corpus for a document specifying instructions for performing a project matching criteria specified in the request;
identifying, by the data processing system, based on the search results, tools required to perform tasks specified in the instructions for performing the project; and
outputting, by the data processing system, the document specifying instructions for performing the project and a listing of required tools for performing tasks specified in the search results to a user via the user computing device.

10. The method of claim 9, further comprising:
performing, by the data processing system, for at least one tool in the listing of required tools, a search of at least one tool provider information source for tool information describing the at least one tool in the listing of required tools; and
outputting, by the data processing system, the tool information obtained from the at least one tool provider information source.

11. A computer program product comprising a computer readable storage medium having a computer readable program stored therein, wherein the computer readable program, when executed on a data processing system, causes the data processing system to:
perform natural language processing of content of a training corpus of electronic documents to identify associations of action terms with required tools for performing actions corresponding to the action terms;
train an ontology model based on the identified associations of the action terms with required tools for performing actions corresponding to the action terms;
perform analysis of electronic documents of one or more other corpora based on the trained ontology model to identify required tools for performing actions specified in the electronic documents; and
annotate one or more of the electronic documents of the one or more other corpora to include required tools annotation metadata identifying tools required to perform actions corresponding to action terms present in the one or more electronic documents to thereby generate at least one updated corpus.

12. The computer program product of claim 11, wherein at least one electronic document of the one or more other corpora does not explicitly indicate, in content of the electronic document, a tool to perform a task specified in the content of the electronic document, and wherein the computer readable program further causes the data processing system to perform analysis of electronic documents of one or more other corpora based on the trained ontology model at least by associating a tool with the task based on at least one action term specified in the content of the electronic document in association with the task.

13. The computer program product of claim 11, wherein the computer readable program further causes the data processing system to perform natural language processing of content of a training corpus at least by performing a morphological similarity analysis that identifies action terms and entities specified in natural language content of the training corpus that have an overlapping stem.

14. The computer program product of claim 11, wherein the computer readable program further causes the data processing system to perform natural language processing of content of a training corpus at least by performing a posteriori tool mention analysis which identifies text in the content of the training corpus where a tool required to perform an action corresponding to an action term in the text is present in the text after an instance of the action term corresponding to the action.

15. The computer program product of claim 11, wherein the ontology model comprises a plurality of tuples, wherein each tuple associates an action term with a corresponding tool for performing an action corresponding to the action term, and wherein the computer readable program further causes the data processing system to perform analysis of electronic documents of one or more other corpora based on the trained ontology model to identify required tools for performing actions specified in the electronic documents at least by matching action terms in the electronic documents with action terms in tuples of the plurality of tuples.

16. The computer program product of claim 15, wherein each tuple further associates the action term and corresponding tool with at least one of an object upon which the action is performed or a confidence score indicating a confidence that the corresponding tool is required to perform an action corresponding to the action term.

17. The computer program product of claim 16, wherein the confidence score is calculated by the data processing system based on a function of a frequency of occurrence of the tuple present in the training corpus.

18. The computer program product of claim 11, wherein the computer readable program further causes the data processing system to perform natural language processing of content of a training corpus at least by:
applying one or more pre-defined textual patterns to the content of the training corpus, wherein each pre-defined textual pattern specifies a mention of a tool name and an action term;
identifying matching portions of text in the content of the training corpus that match one or more of the pre-defined textual patterns; and
extracting, from the matching portions of text, a tool name and action term.

19. The computer program product of claim 11, wherein the computer readable program further causes the data processing system to:
receive, from a user computing device, a request for a project to be performed by the user;
perform a search of the updated corpus for a document specifying instructions for performing a project matching criteria specified in the request;
identify, based on the search results, tools required to perform tasks specified in the instructions for performing the project; and
output the document specifying instructions for performing the project and a listing of required tools for performing tasks specified in the search results to a user via the user computing device.

20. An apparatus comprising:
a processor; and
a memory coupled to the processor, wherein the memory comprises instructions which, when executed by the processor, cause the processor to:
perform natural language processing of content of a training corpus of electronic documents to identify associations of action terms with required tools for performing actions corresponding to the action terms;
train an ontology model based on the identified associations of the action terms with required tools for performing actions corresponding to the action terms;
perform analysis of electronic documents of one or more other corpora based on the trained ontology model to identify required tools for performing actions specified in the electronic documents; and
annotate one or more of the electronic documents of the one or more other corpora to include required tools annotation metadata identifying tools required to perform actions corresponding to action terms present in the one or more electronic documents to thereby generate at least one updated corpus.
